(19) United States
(12) Patent Application Publication
(10) Pub. No.: US 2026/0129043 A1
(43) Pub. Date: May 7, 2026

(54) METHOD AND APPARATUS FOR ESTABLISHING CONNECTION

(71) Applicant: BEIJING XIAOMI MOBILE SOFTWARE CO., LTD., Beijing (CN)

(72) Inventors: Haoran LIANG, Beijing (CN); Wei LU, Beijing (CN)

(73) Assignee: BEIJING XIAOMI MOBILE SOFTWARE CO., LTD., Beijing (CN)

(21) Appl. No.: 19/114,605

(22) PCT Filed: Sep. 30, 2022
(86) PCT No.: PCT/CN2022/123346

§ 371 Date: Mar. 24, 2025

(51) Int. Cl. H04L 9/40; H04L 67/141

(52) U.S. Cl. CPC H04L 63/0869; H04L 63/0823; H04L 63/166; H04L 67/141

(57) ABSTRACT

A method for establishing a connection, performed by a home edge configuration server (H-ECS), includes: determining authorization information of a visited edge configuration server (V-ECS), and a target V-ECS; performing mutual identity authentication with the target V-ECS; in response to success of the mutual identity authentication, determining whether the target V-ECS is allowed to establish a connection with the H-ECS based on identity information authenticated and the authorization information of the V-ECS; and in response to the target V-ECS being allowed to establish the connection with the H-ECS, establishing a connection with the target V-ECS.

### CROSS-REFERENCE TO RELATED APPLICATION

This application is a U.S. national phase of International Application No. PCT/CN 2022/123346, filed Sep. 30, 2022, the entire content of which is incorporated herein by reference.

### TECHNICAL FIELD

The disclosure relates to a field of communication technologies, and particularly to a method and an apparatus for establishing a connection.

### BACKGROUND

In a roaming architecture, edge configuration servers (ECSs) are provided in both a home public land mobile network (HPLMN) and a visited public land mobile network (VPLMN). Specifically, an edge enabler client (EEC) in a terminal may obtain a service from a visited ECS (V-ECS) and a visited edge enabler server (V-EES). A new connection between the ECSs (i.e., between the V-ECS and the H-ECS) is defined. This new connection may be used for an EES discovery or a V-ECS information retrieval in a roaming PLMN.

A malicious H-ECS may obtain EES information or V-ECS information via the new connection, which may attack to cause leakage of topology details and server information in a VPLMN domain. A malicious V-ECS may obtain terminal information from the H-ECS via the new connection, which may cause privacy exposure of the terminal.

### SUMMARY

In a first aspect, embodiments of the disclosure provide a method for establishing a connection, performed by a home edge configuration server (H-ECS), including:
determining authorization information of a visited ECS (V-ECS), and a target V-ECS;
performing mutual identity authentication with the target V-ECS;
in response to success of the mutual identity authentication, determining whether the target V-ECS is allowed to establish a connection with the H-ECS based on identity information authenticated and the authorization information of the V-ECS; and
in response to the target V-ECS being allowed to establish the connection with the H-ECS, establishing a connection with the target V-ECS.

In a second aspect, embodiments of the disclosure provide a method for establishing a connection, performed by a V-ECS, including:
performing mutual identity authentication with a H-ECS;
in response to success of the mutual identity authentication, determining whether the H-ECS is allowed to establish a connection with the V-ECS based on identity information authenticated and authorization information of the H-ECS; and
in response to the H-ECS being allowed to establish the connection with the V-ECS, establishing a connection with the H-ECS.

In a third aspect, embodiments of the disclosure provide a home edge configuration server (H-ECS), including: a processor; and a memory for storing instructions executable by the processor. The processor is configured to execute the method in the first aspect.

In a fourth aspect, embodiments of the disclosure provide a visited edge configuration server (V-ECS), including: a processor; and a memory for storing instructions executable by the processor. The processor is configured to execute the method in the second aspect.

### BRIEF DESCRIPTION OF THE DRAWINGS

In order to clearly illustrate technical solutions of embodiments of the disclosure or a background, a brief description is made below to accompanying drawings used in embodiments or the background.

FIG. 1 is a schematic diagram illustrating an architecture of a communication system according to an embodiment of the disclosure.

FIG. 2 is a flow chart illustrating a method for establishing a connection according to an embodiment of the disclosure.

FIG. 3 is a flow chart illustrating a method for establishing a connection according to another embodiment of the disclosure.

FIG. 4 is a flow chart illustrating a method for establishing a connection according to another embodiment of the disclosure.

FIG. 5 is a flow chart illustrating a method for establishing a connection according to another embodiment of the disclosure.

FIG. 6 is a flow chart illustrating a method for establishing a connection according to another embodiment of the disclosure.

FIG. 7 is a flow chart illustrating a method for establishing a connection according to another embodiment of the disclosure.

FIG. 8 is an interaction diagram illustrating a method for establishing a connection according to another embodiment of the disclosure.

FIG. 9 is a block diagram illustrating a communication device according to an embodiment of the disclosure.

FIG. 10 is a block diagram illustrating a communication device according to another embodiment of the disclosure.

FIG. 11 is a block diagram illustrating a chip according to another embodiment of the disclosure.

### DETAILED DESCRIPTION

To facilitate understanding, terms involved in the disclosure are firstly introduced below.

### 1. Home Public Land Mobile Network (HPLMN)

The HPLMN is a PLMN to which a terminal belongs. In other words, an international mobile subscriber identity (IMSI) in a universal subscriber identity module (USIM) card in the terminal includes a mobile country code (MCC) and a mobile network code (MNC), which are identical to an MCC and an MNC of the HPLMN. For a given USIM card, there is only one HPLMN.

### 2. Visited Public Land Mobile Network (VPLMN)

The VPLMN is a PLMN accessed by the terminal. The PLMN are not fully identical to the MCC and the MNC in the IMSI stored In the USIM card. When the terminal loses coverage, one VPLMN may be selected.

To better understand a migration method in embodiments of the disclosure, a communication system applicable to the embodiments is first described below.

### 3. Home Edge Configuration Server (H-ECS)

The H-ECS is an ECS located in a home network. The H-ECS may be used to configure and manage a home edge enabler server (H-EES) located in the home network, communicate with other servers in the home network, or communicate with a visited ECS (V-ECS).

### 4. Visited Edge Configuration Server (V-ECS)

The V-ECS is an ECS of a network at a visited place. The V-ECS may be used to configure and manage a V-EES located in an access network, and communicate with other servers in the access network, or communicate with the H-ECS.

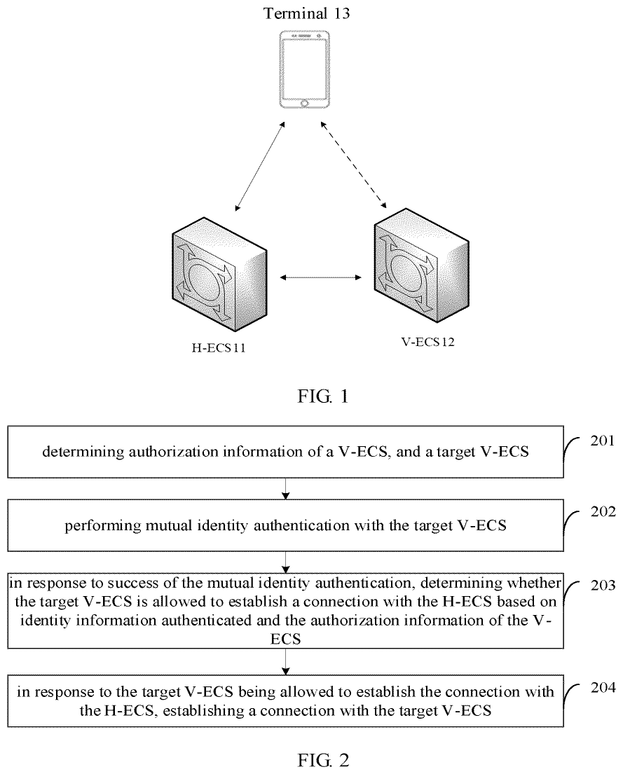

Please refer to FIG. 1, which is a schematic diagram illustrating an architecture of a communication system according to an embodiment of the disclosure. The communication system may include, but is not limited to, one network device and one terminal. The number and form of devices illustrated in FIG. 1 are only illustrated as an example, and do not constitute a limitation on embodiments of the disclosure. The communication system may include two or more network devices and two or more terminals in a practical application. The communication system in FIG. 1 including one H-ECS11, one V-ECS12 and one terminal 13 is illustrated as an example.

It needs to be noted that the technical solution of embodiments of the disclosure may be applied to various communication systems, such as, a long term evolution (LTE) system, a 5th generation (5G) mobile communication system, a 5G new radio (NR) system, or other new mobile communication systems in the future.

The H-ECS11 and the V-ECS12 in embodiments of the disclosure are devices that provide a channel for the terminal to enter the network and a function for communication with other server devices.

Alternatively, the communication system also includes a home network device and a visited network device. The network device is an entity on the network side for sending or receiving a signal, such as, an evolved NodeB (eNB), a transmission reception point (TRP), a next generation NodeB (gNB) in an NR system, a base station in other mobile communication system in the future, or an access node in a wireless fidelity (WiFi) system. Embodiments of the disclosure do not limit a detailed technology and a detailed device form employed by the network device. The network device in embodiments of the disclosure may include a central unit (CU) and a distributed unit (DU), in which the CU may also be called a control unit. A protocol layer of the network device, such as, a base station, may be divided by employing a CU-DU structure. Some functions of the protocol layer are centrally controlled by the CU, some or all of remaining functions of the protocol layer are distributed in the DU, and the DU is centrally controlled by the CU.

The terminal 13 in embodiments of the disclosure is an entity on the user side for receiving or sending a signal, such as a mobile phone. The terminal may also be called a user equipment (UE), a mobile station (MS), a mobile terminal (MT), etc. The terminal may be a car with communication function, a smart car, a mobile phone, a wearable device, a tablet (Pad), a computer with a wireless receiving and sending function, a virtual reality (VR) terminal, an augmented reality (AR) terminal, a wireless terminal in industrial control, a wireless terminal in autonomous driving, a wireless terminal in remote medical surgery, a wireless terminal in smart grid, a wireless terminal in transportation safety, a wireless terminal in smart city, a wireless terminal in smart home, etc. A detailed technology and a detailed device form used by the terminal are not limited in embodiments of the disclosure.

It may be understood that the communication system in embodiments of the disclosure is to more clearly illustrate the technical solution of embodiments of the disclosure, and does not constitute a limitation on the technical solution in embodiments of the disclosure. Those skilled in the art may know, with the evolution of the system architecture and the emergence of a new service scenario, the technical solution in embodiments of the disclosure is also applicable to similar technical problems.

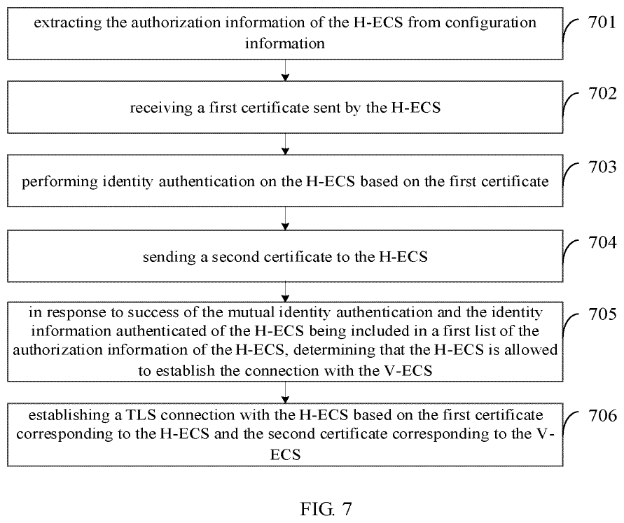

In this system, the H-ECS may implement the method in any one of embodiments of FIGS. 2 to 5 in the disclosure. In addition, the V-HCS may implement the method in FIGS. 6 to 7 in the disclosure.

It may be understood that the communication system in embodiments of the disclosure is to more clearly illustrate the technical solution of embodiments of the disclosure, and does not constitute a limitation on the technical solution in embodiments of the disclosure. Those skilled in the art may know, with the evolution of the system architecture and the emergence of a new service scenario, the technical solution in embodiments of the disclosure is also applicable to similar technical problems.

In the disclosure, for an existing roaming architecture, a malicious H-ECS may obtain EES information or V-ECS information via a new connection, which may attack to cause leakage of topology details and server information in a VPLMN domain. A malicious V-ECS may obtain UE information from the H-ECS via the new connection, which may cause privacy exposure of the UE. Therefore, a method for establishing a connection is provided. Before establishing a connection between ECSs, mutual identity authentication is firstly performed, and then connection authentication determination is performed after the authentication is passed. Only when the connection is allowed to establish, a direct connection between the two ECSs is established, which improves security of the connection between the ECSs, that is, avoids the leakage of topology details and server information in the VPLMN domain, avoids the privacy exposure of the terminal, improves security and reliability of information in a roaming scenario, and improves performance of the communication system.

In combination with flow charts in the disclosure, a detailed description is made to the method for establishing a connection provided in embodiments of the disclosure.

Please refer to FIG. 2, which is a flow chart illustrating a method for establishing a connection according to an embodiment of the disclosure. The method in embodiments of the disclosure is performed by an H-ECS. As illustrated in FIG. 2, the method may include, but is not limited to, the following.

At block S201, authorization information of a V-ECS, and a target V-ECS are determined.

The target V-ECS is an ECS to be connected with the H-ECS.

Alternatively, the authorization information of the V-ECS may include identity information of a trusted V-ECS, or a certificate corresponding to the trusted V-ECS, and so on.

Alternatively, the authorization information of the V-ECS may further include identity information of the V-ECS that is allowed to establish a connection with the H-ECS, and a corresponding certificate, and so on.

Alternatively, the H-ECS may obtain the authorization information of the V-ECS from a pre-configured storage area in local; or, the H-ECS may obtain the authorization information of the V-ECS from a terminal, which is not limited in the disclosure.

At block S202, mutual identity authentication with the target V-ECS is performed.

In the disclosure, the H-ECS may perform the mutual identity authentication with the target V-ECS after determining the target V-ECS.

Alternatively, in the mutual identity authentication, the H-ECS may be employed to determine whether the target V-ECS is a trusted ECS; or, may be used by the target V-ECS to determine whether the H-ECS is a trusted ECS; or, may be used by the H-ECS to determine whether the target V-ECS is a trusted ECS and by the target V-ECS to determine whether the H-ECS is a trusted ECS.

At block S203, in response to success of the mutual identity authentication, it is determined whether the target V-ECS is allowed to establish a connection with the H-ECS based on identity information authenticated and the authorization information of the V-ECS.

At block S204, in response to the target V-ECS being allowed to establish the connection with the H-ECS, a connection with the target V-ECS is established.

Alternatively, the identity information authenticated may be a fully qualified domain name (FQDN) of an ECS, or any other information that uniquely represents an identity of the ECS in a network, such as an Internet protocol (IP) address of the ECS.

For example, the identity information authenticated of the target V-ECS may include the FQDN or IP address corresponding to the target V-ECS, and so on, which is not limited in the disclosure.

In the disclosure, the V-ECS that is allowed by the terminal to establish the connection with the H-ECS may not include a target V-ECS currently determined by the H-ECS. Therefore, after the mutual identity authentication is performed with the V-ECS, the H-ECS may further determine whether the target V-ECS is allowed to establish the connection with the H-ECS based on the identity information authenticated and the authorization information of the V-ECS. In the case that the target V-ECS is allowed to establish the connection with the H-ECS, a connection between the V-ECS and the H-ECS may be established. The connection is established only after the mutual identity authentication and permission, which ensures security of the connection, and avoids potential information leakage in the VPLMN domain or in the terminal via the connection.

Alternatively, in the case that the target V-ECS is not allowed to establish the connection with the H-ECS, the H-ECS may terminate a process of establishing the connection.

Alternatively, the H-ECS may establish a transport layer security (TLS) connection with the target V-ECS based on a first certificate corresponding to the H-ECS and a second certificate corresponding to the target V-ECS. In other words, the H-ECS and the target V-ECS may encrypt information exchanged in the TLS connection between the H-ECS and the target V-ECS based on the first certificate and the second certificate; or the H-ECS may encrypt a key used for the information exchanged based on the second certificate corresponding to the target V-ECS, and correspondingly, the target V-ECS may encrypt the key used for the information exchanged based on the first certificate corresponding to the H-ECS, and so on, which is not limited in the disclosure.

It needs to be noted that, the H-ECS may further discover a target EES after establishing the connection with the target V-ECS. For example, the target EES may be discovered based on whether a service area of the EES may cover the location information of the terminal. Then, the H-ECS may return an identifier of the target EES to the terminal or a source EES.

In the disclosure, the H-ECS first determines the authorization information of the V-ECS and the target V-ECS; performs the mutual identity authentication with the target V-ECS; after the success of the mutual identity authentication, determines whether the target V-ECS is allowed to establish the connection with the H-ECS based on the identity information authenticated and the authorization information of the V-ECS; and establishes the connection with the target V-ECS in response to the target V-ECS being allowed to establish the connection with the H-ECS. Thus, before the connection between the H-ECS and the target V-ECS is established, the identity authentication and authorization are performed to avoid information leakage via the connection, improve security and reliability of the connection between the ECSs, and improve a performance of a system in the roaming scenario.

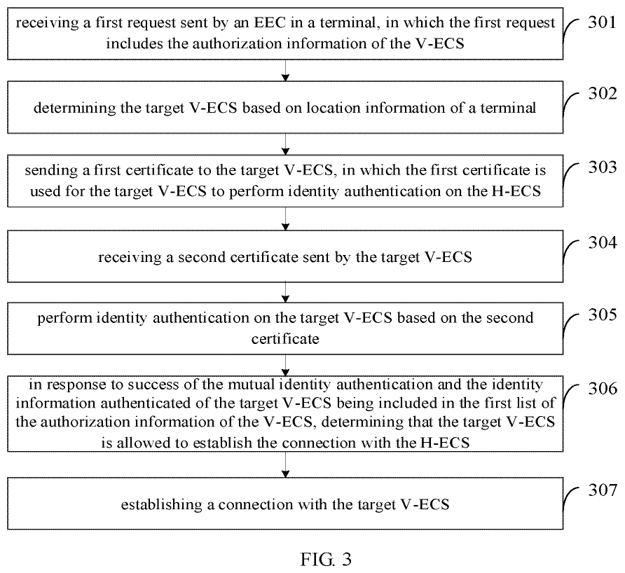

Please refer to FIG. 3, which is a flow chart illustrating a method for establishing a connection according to another embodiment of the disclosure. The method in embodiments of the disclosure is performed by an H-ECS. As illustrated in FIG. 3, the method may include, but is not limited to, the following.

At block S301, a first request sent by an edge enabler client (EEC) in a terminal is received, in which the first request includes the authorization information of the V-ECS.

Alternatively, the first request may also include the location information of the terminal.

In embodiments of the disclosure, when the terminal needs to access the V-ECS, the terminal may send the first request to the H-ECS by the EEC, and the authorization information of the V-ECS (such as the certificate and/or identity information of the V-ECS that is allowed to be accessed) that is allowed by the terminal is sent to the H-ECS.

At block S302, the target V-ECS is determined based on location information of a terminal.

Alternatively, in the case that the first request includes the location information of the terminal, the H-ECS may determine a target EES (T-EES) that may cover a location of the terminal based on the location information of the terminal included in the first request, and then determine an ECS corresponding to the T-EES as the target V-ECS.

Alternatively, in the case that the first request does not include the location information of the terminal, the H-ECS also needs to interact with a core network device to determine the location information of the terminal, and then determines the target V-ECS based on the location information of the terminal determined.

At block S303, a first certificate is sent to the target V-ECS, in which the first certificate is used for the target V-ECS to perform identity authentication on the H-ECS.

Alternatively, the first certificate may be any information that may represents information of an identity of the H-ECS. The first certificate may be pre-configured in the H-ECS by an operator, or determined by the H-ECS based on an agreement and information of the H-ECS, which is not limited in the disclosure.

Alternatively, the H-ECS may also determine whether the V-ECS is trusted before sending the first certificate to the target ECS. For example, the H-ECS determines that the identity information (such as the FQDN and IP address) of the target V-ECS is in a first list in the authorization information of the V-ECS, and/or that a corresponding second certificate is in the first list of the authorization information of the V-ECS. In other words, the H-ECS sends the first certificate to the target V-ECS only when the target V-ECS is allowed to establish the connection with the H-ECS, and the identity authentication is performed on the H-ECS by the target V-ECS.

At block S304, a second certificate sent by the target V-ECS is received.

At block S305, identity authentication is performed on the target V-ECS based on the second certificate.

In embodiments of the disclosure, after the target V-ECS authenticates the first certificate of the H-ECS, in the case that it is determined that the H-ECS is trusted, the second certificate corresponding to the target V-ECS may be sent to the H-ECS, and then the identity of the target V-ECS is authenticated by the H-ECS, which ensures that both the H-ECS and the V-ECS are trusted ECSs, and ensures the security of the connection.

Alternatively, the H-ECS may authenticate the second certificate using a root certificate authority (CA) corresponding to the target V-ECS. In response to success of the authentication, it is determined that information in the second certificate is identity information authenticated of the V-ECS, that is, it is determined that the identity of the target V-ECS is legitimate, otherwise the identity of the target V-ECS is not legitimate.

At block S306, in response to success of the mutual identity authentication and the identity information authenticated of the target V-ECS being included in the first list of the authorization information of the V-ECS, it is determined that the target V-ECS is allowed to establish the connection with the H-ECS.

The first list of the authorization information of the V-ECS includes the identity information of one or more V-ECSs that are allowed to establish the connection with the H-ECS or second certificates corresponding to the one or more V-ECSs. Alternatively, the identity information authenticated of the target V-ECS may be an FQDN of the target V-ECS or an IP address of the target V-ECS, which is not limited in the disclosure.

Alternatively, in the disclosure, in response to the second certificate used for successfully authenticating the target V-ECS being included in the first list of the authorization information of the V-ECS, the H-ECS determines that the target V-ECS is allowed to establish the connection with the H-ECS.

Alternatively, in response to the identity information authenticated of the target V-ECS being included in the first list of the authorization information of the V-ECS, and the second certificate used for successfully authenticating the target V-ECS being included in the first list of the authorization information of the V-ECS, the H-ECS determines that the target V-ECS is allowed to establish the connection with the H-ECS.

At block S307, a connection with the target V-ECS is established.

A detailed implementation of the above actions at block S307 may be described in detail with reference to any one of embodiments of the disclosure, which is not repeated here.

It needs to be noted that the H-ECS may further discover a target EES after establishing the connection with the target V-ECS. After that, the H-ECS may return an identity of the target EES to the terminal.

In the disclosure, when the H-ECS receives the authorization information of the V-ECS sent by the terminal, the H-ECS first determines the target V-ECS based on the location information of the terminal; performs the mutual identity authentication by interacting with the certificate of the target V-ECS; after the success of the mutual identity authentication, determines whether the target V-ECS is allowed to establish the connection with the H-ECS based on the identity information authenticated and the authorization information of the V-ECS; and establishes the connection with the target V-ECS in response to the target V-ECS being allowed to establish the connection with the H-ECS. Thus, before the connection between the H-ECS and the target V-ECS is established, the identity authentication and authorization are performed, and check whether the connection is allowed to be established, to prevent information leakage by the connection, to improve security and reliability of the connection between the ECSs, and to improve a performance of a system in a roaming scenario.

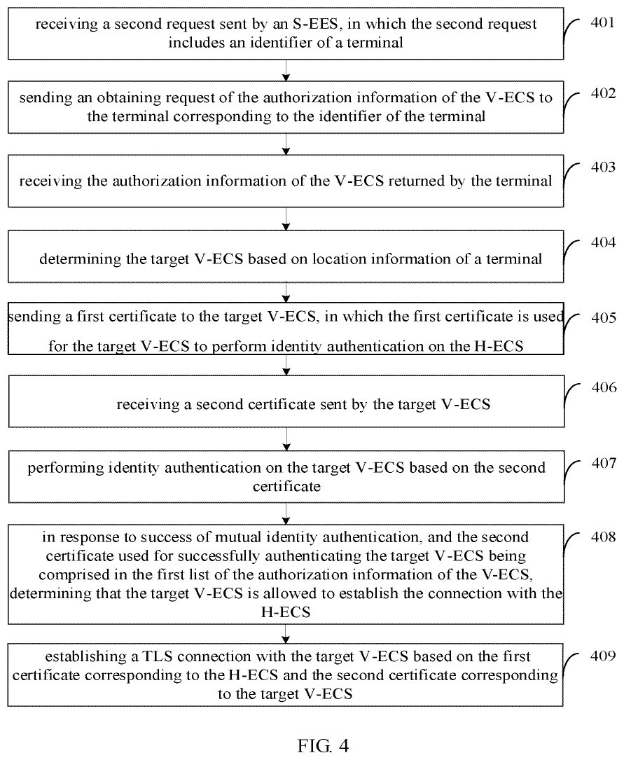

Please refer to FIG. 4, which is a flow chart illustrating a method for establishing a connection according to another embodiment of the disclosure. The method in embodiments of the disclosure may be performed by an H-ECS. As illustrated in FIG. 4, the method may include, but is not limited to, the following.

At block S401, a second request sent by a source EES (S-EES) is received, in which the second request includes an identifier of a terminal.

The identifier of the terminal may be any information of the terminal that may be uniquely determined by the H-ECS, such as, a serial number of the terminal in the H-ECS, or a device identification code of the terminal, etc., which is not limited in the disclosure.

At block S402, an obtaining request of the authorization information of the V-ECS is sent to the terminal corresponding to the identifier of the terminal.

At block S403, the authorization information of the V-ECS returned by the terminal is received.

The S-EES is an EES that currently provides a service to the terminal.

In embodiments of the disclosure, the S-EES needs to query a target V-ECS for the terminal, the S-EES may send the second request to the H-ECS to request the H-ECS to retrieve the target V-ECS for the terminal. After that, the H-ECS may request the authorization information corresponding to the V-ECS from the terminal.

At block S404, the target V-ECS is determined based on location information of a terminal.

Alternatively, the location information of the terminal may be synchronously returned when returning the authorization information of the V-ECS to the H-ECS; or, may be determined by the H-ECS by an interaction with a core network, which is not limited in the disclosure.

At block S405, a first certificate is sent to the target V-ECS, in which the first certificate is used for the target V-ECS to perform identity authentication on the H-ECS.

At block S406, a second certificate sent by the target V-ECS is received.

At block S407, identity authentication is performed on the target V-ECS based on the second certificate.

At block S408, in response to success of the mutual identity authentication and the second certificate used for successfully authenticating the target V-ECS being included in the first list of the authorization information, it is determined that the target V-ECS is allowed to establish the connection with the H-ECS.

Alternatively, when the H-ECS determines the identity information authenticated of the target V-ECS, such as an FQDN or IP address in included in the first list of the authorization information of the V-ECS, the H-ECS may also determine that the target V-ECS is allowed to establish the connection with the H-ECS.

At block S409, a TLS connection with the target V-ECS is established based on the first certificate corresponding to the H-ECS and the second certificate corresponding to the target V-ECS.

A detailed implementations of actions at blocks S404 to S407 may be described in detail with reference to any one of embodiments of the disclosure, which is not repeated here.

It needs to be noted that the H-ECS may further discover a target EES after establishing the connection with the target V-ECS. After that, the H-ECS may return an identity of the target EES to the source EES.

In the disclosure, when the H-ECS receives the authorization information of the V-ECS sent by the terminal, the H-ECS first requests the authorization information of the V-ECS from the terminal, determines the target V-ECS based on the location information of the terminal; performs the mutual identity authentication by interacting with the certificate of the target V-ECS; determines whether the target V-ECS is allowed to establish the connection with the H-ECS after the success of the mutual identity authentication; and establishes the connection with the target V-ECS in response to the target V-ECS being allowed to establish the connection with the H-ECS. Thus, before the connection between the H-ECS and the target V-ECS is established, the identity authentication and authorization performed, and it is also checked whether the connection is allowed, to avoid information leakage via the connection, to improve security and reliability of the connection between the ECSs, and to improve a performance of a system in a roaming scenario.

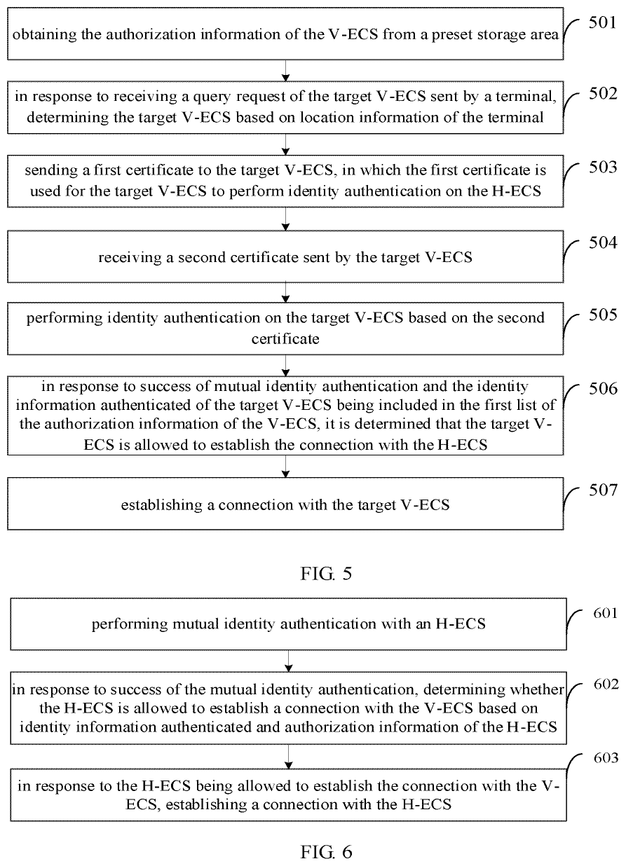

Please refer to FIG. 5, which is a flow chart illustrating a method for establishing a connection according to another embodiment of the disclosure. The method in embodiments of the disclosure is performed by an H-ECS. As illustrated in FIG. 5, the method may include, but is not limited to, the following.

At block S501, the authorization information of the V-ECS is obtained from a preset storage area.

Alternatively, the authorization information of the V-ECS in the preset storage area may be pre-configured in the H-ECS by an operator; or may be requested from the terminal when the H-ECS established the connection with the V-ECS previously; or may be determined by the H-ECS based on an agreement, which is not limited in the disclosure.

At block S502, in response to receiving a query request of the target V-ECS sent by a terminal, the target V-ECS is determined based on location information of the terminal.

The actions at block S502 may also be executed before the actions at block S501. That is, in the case that the H-ECS receives the query request of the target V-ECS from the terminal and the terminal does not send the authorization information of a V-ECS corresponding to the terminal to the H-ECS, the H-ECS may obtain stored authorization information of the V-ECS from a local preset storage area of the terminal, which is not limited in the disclosure.

In the disclosure, when the terminal needs to access a VPLMN after losing a coverage, the query request of the target V-ECS may be sent to the H-ECS. The query request may include the location information of the terminal, or may not include the location information of the terminal. The H-ECS may determine the location information of the terminal by an interaction with the core network, which is not limited in the disclosure.

At block S503, a first certificate is sent to the target V-ECS, in which the first certificate is used for the target V-ECS to perform identity authentication on the H-ECS.

At block S504, a second certificate sent by the target V-ECS is received.

At block S505, identity authentication is performed on the target V-ECS based on the second certificate.

At block S506, in response to success of the mutual identity authentication and the identity information authenticated of the target V-ECS being included in the first list of the authorization information of the V-ECS, it is determined that the target V-ECS is allowed to establish the connection with the H-ECS.

At block S507, a connection with the target V-ECS is established.

A detailed implementation process at blocks S502 to S507 may be described in detail with reference to any one of embodiments of the disclosure, which is not repeated here.

In the disclosure, the H-ECS may first determine the target V-ECS based on the location information of the terminal when receiving the query request of the target V-ECS sent by the terminal; perform the mutual identity authentication by interacting with the certificate of the target V-ECS based on the authorization information of the V-ECS in local; determine whether the target V-ECS is allowed to establish the connection with the H-ECS after the success of the mutual identity authentication; and establish the connection with the target V-ECS in response to the target V-ECS being allowed to establish the connection with the H-ECS. Thus, before the connection between the H-ECS and the target V-ECS is established, the identity authentication and authorization are performed, and it is also checked whether the connection is allowed, to avoid information leakage via the connection, to improve security and reliability of the connection between the ECSs, and to improve a performance of a system in a roaming scenario.

Please refer to FIG. 6, which is a flow chart illustrating a method for establishing a connection according to another embodiment of the disclosure. The method in embodiments is performed by a V-ECS. As illustrated in FIG. 6, the method may include, but is not limited to, the following.

At S601, mutual identity authentication with an H-ECS is performed.

A detailed implementation of the mutual identity authentication between the V-ECS and the H-ECS may be described in detail with reference to any one of embodiments of the disclosure, which will not be repeated here.

At S602, in response to success of the mutual identity authentication, whether the H-ECS is allowed to establish a connection with the V-ECS is determined based on identity information authenticated and authorization information of the H-ECS.

Alternatively, the authorization information of the H-ECS may be configured by an operator from configuration information in the V-ECS, such that the V-ECS may extract the authorization information of the H-ECS from the configuration information; or may be generated by the V-ECS based on an agreement, which is not limited in the disclosure.

Alternatively, the authorization information of the H-ECS may include identity information of a trusted H-ECS, or a certificate corresponding to the trusted H-ECS, and so on.

Alternatively, the authorization information of the H-ECS may also include the identity information of the H-ECS and the corresponding certificate that allows the connection with the V-ECS.

At S603, in response to the H-ECS being allowed to establish the connection with the V-ECS, a connection with the H-ECS is established.

Alternatively, the identity information authenticated may be an FQDN of an ECS, or may also be any other information that uniquely represents an identity of the ECS in a network, such as, a network protocol (IP) address of the ECS.

For example, identity information authenticated of the H-ECS may be an FQDN, or the IP address corresponding to the H-ECS, etc., which is not limited in the disclosure.

In the disclosure, the H-ECS that is allowed by the V-ECS to establish the connection with the V-ECS may not include an H-ECS that completes the identity authentication currently. Therefore, after the H-ECS performs the identity authentication with the V-ECS, the V-ECS may also further determine whether the H-ECS is allowed to establish the connection with the V-ECS based on the identity information authenticated and the authorization information of the H-ECS. In the case that the H-ECS is allowed to establish the connection with the V-ECS, a connection between the H-ECS and the V-ECS may be established. The connection is established only after the identity authentication and permission, thus ensuring security of the connection, avoiding potential information leakage in a VPLMN domain or in the terminal by the connection.

Alternatively, in the case that the H-ECS is not allowed to establish the connection with the V-ECS, the V-ECS may terminate a process of establishing the connection.

Alternatively, the V-ECS may establish a TLS connection with the target V-ECS based on a first certificate corresponding to the H-ECS and a second certificate corresponding to the target V-ECS. In other words, the H-ECS and the V-ECS may encrypt information exchanged in the TLS connection based on the first certificate and the second certificate; or the H-ECS may encrypt a key used for the information exchanged based on the second certificate corresponding to the V-ECS, and correspondingly, the V-ECS may encrypt the key used for the information exchanged based on the first certificate corresponding to the H-ECS, and so on, which is not limited in the disclosure.

In the disclosure, the V-ECS may first perform the mutual identity authentication with the H-ECS before establishing the connection with the H-ECS; in response to the success of the mutual identity authentication, determine whether the H-ECS is allowed to establish the connection with the V-ECS based on the identity information authenticated and the authorization information of the H-ECS; and establish the connection with the H-ECS in response to the H-ECS being allowed to establish the connection with the V-ECS. Thus, before establishing the connection between the H-ECS and the target V-ECS, the identity authentication and authorization are performed, to avoid information leakage by the connection, to improve security and reliability of the connection between the ECSs, and to improve a performance of a system in a roaming scenario.

Please refer to FIG. 7, which is a flow chart illustrating a method for establishing a connection according to another embodiment of the disclosure. The method is performed by a V-ECS. As illustrated in FIG. 7, the method may include, but is not limited to, the following.

At block S701, the authorization information of the H-ECS is extracted from configuration information.

Alternatively, the V-ECS may also determine the authorization information of the H-ECS based on the agreement, which is not limited in the disclosure.

At block S702, a first certificate sent by the H-ECS is received.

The V-ECS may also execute actions at block S702 first and then perform actions at block S701, which is not limited in the disclosure.

Alternatively, the first certificate may be any information that may represents an identity of the H-ECS. The first certificate may be pre-configured in the H-ECS by an operator, or determined by the H-ECS based on an agreement and information of the H-ECS, which is not limited in the disclosure.

At block S703, identity authentication is performed on the H-ECS based on the first certificate.

Alternatively, the V-ECS may use a root CA corresponding to the H-ECS to authenticate the first certificate. In response to success of the authentication, it is determined that information in the first certificate is the identity information authenticated of the H-ECS, that is, it is determined that the identity of the H-ECS is legal, otherwise that the identity of the H-ECS is illegal.

At block S704, a second certificate is sent to the H-ECS.

In the disclosure, the V-ECS may first authenticate the identity of the H-ECS based on the first certificate after receiving the first certificate sent by the H-ECS. In the case that the authentication is passed, it is determined that the H-ECS is a legal ECS, such that the second certificate corresponding to the V-ECS may be sent to the H-ECS, and the H-ECS performs authentication on the V-ECS based on the second certificate.

Alternatively, since a purpose of the V-ECS sending the second certificate to the H-ECS is to establish a connection between the V-ECS and the H-ECS after the mutual identity authentication is passed. In order to avoid an invalid authentication process, in the disclosure, the V-ECS may also first determine whether the H-ECS is allowed to establish a connection with the V-ECS before sending the second certificate to the H-ECS. Only if it is determined that the H-ECS is allowed to establish the connection with the V-ECS, the second certificate is sent to the H-ECS.

At block S705, in response to success of the mutual identity authentication and the identity information authenticated of the H-ECS being included in a first list of the authorization information of the H-ECS, it is determined that the H-ECS is allowed to establish the connection with the V-ECS.

The first list of the authorization information of the H-ECS includes identity information and/or first certificates of one or more H-ECS that are allowed to establish the connection with the V-ECS.

Alternatively, the identity information authenticated of the H-ECS may be an FQDN of the H-ECS, or an IP address corresponding to the H-ECS, which is not limited in the disclosure.

Alternatively, in response to the identity information authenticated of the H-ECS being included in the first list of the authorization information of the H-ECS, the V-ECS may determine that the H-ECS is allowed to establish the connection with the V-ECS.

Alternatively, in response to the first certificate used for successfully authenticating the H-ECS being included in the first list of the authorization information of the H-ECS, the V-ECS may also determine that the H-ECS is allowed to establish the connection with the V-ECS.

Alternatively, in response to the identity information authenticated of the H-ECS being included in the first list of the authorization information of the H-ECS, and the first certificate used for successfully authenticating the H-ECS being included in the first list of the authorization information of the H-ECS, the V-ECS may determine that the H-ECS is allowed to establish the connection with the V-ECS.

At block S706, a TLS connection with the H-ECS is established based on the first certificate corresponding to the H-ECS and the second certificate corresponding to the V-ECS.

A detailed implementation at block S706 may be described in detail with reference to any one of embodiments of the disclosure, which is not repeated here.

In the disclosure, the V-ECS may first perform the mutual identity authentication with the H-ECS before establishing the connection with the H-ECS; in response to the success of the mutual identity authentication, determine whether the H-ECS is allowed to establish the connection with the V-ECS based on the identity information authenticated and the authorization information of the H-ECS; and establish the connection with the H-ECS in response to the H-ECS being allowed to establish the connection with the V-ECS. Thus, before establishing the connection between the H-ECS and the target V-ECS, the identity authentication and authorization are performed, to avoid information leakage by the connection, to improve security and reliability of the connection between the ECSs, and to improve a performance of a system in a roaming scenario.

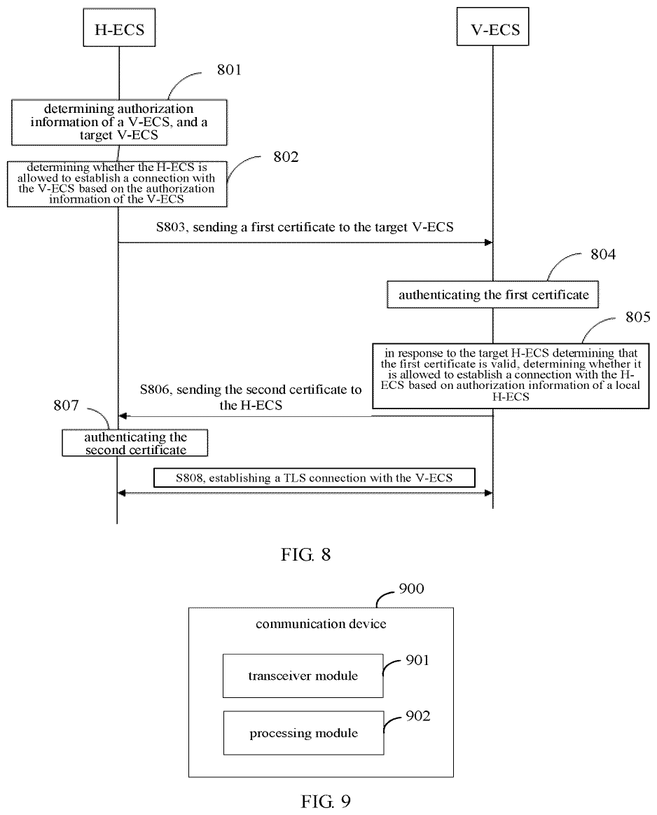

Please refer to FIG. 8, which is an interaction diagram illustrating a method for establishing a connection according to another embodiment of the disclosure. As illustrated in FIG. 8, the method may include, but is not limited to, the following.

At step S801, an H-ECS determines authorization information of a V-ECS, and a target V-ECS.

At step S802, the H-ECS determines whether the H-ECS is allowed to establish a connection with the V-ECS based on the authorization information of the V-ECS.

It needs to be noted that if the H-ECS determines that the H-ECS is not allowed to establish the connection with the target V-ECS, the V-ECS may terminate a process of establishing the connection.

At step S803, the H-ECS sends a first certificate to the target V-ECS after determining that the H-ECS is allowed to establish the connection with the V-ECS.

At step S804, a target H-ECS authenticates the first certificate.

At step S805, in response to the target H-ECS determining that the first certificate is valid, the target V-ECS determines whether the target V-ECS is allowed to establish a connection with the H-ECS based on authorization information of a local H-ECS.

At step S806, the target V-ECS determines that the target V-ECS is allowed to establish the connection with the H-ECS, and sends a second certificate to the H-ECS.

At step S807, the H-ECS authenticates the second certificate.

At step S808, the H-ECS determines that the second certificate is valid, and establishes a TLS connection with the V-ECS.

In the disclosure, the H-ECS performs the mutual identity authentication with the target V-ECS after determining the authorization information of the V-ECS and the target V-ECS; and, the H-ECS establishes the connection with the target V-ECS after the success of the mutual identity authentication and the V-ECS and the target V-ECS are ECSs that are allowed to establish a connection. Thus, before establishing the connection between the H-ECS and the target V-ECS, the identity authentication and authorization are performed, to avoid information leakage by the connection, to improve security and reliability of the connection between the ECSs, and to improve a performance of a system in a roaming scenario.

Please refer to FIG. 9, which is a block diagram illustrating a communication device according to an embodiment of the disclosure. The communication device 900 illustrated in FIG. 9 may include a transceiver module 901 and a processing module 902. The transceiver module 901 may include a sending module and/or a receiving module, in which the sending module is configured to achieve a sending function, and the receiving module is configured to achieve a receiving function. The transceiver module 901 may achieve the sending function and/or the receiving function.

It may be understood that the communication device 900 may be an H-ECS, or a device in an H-ECS, or a device capable of being used in combination with an H-ECS.

The communication device 900 is in an H-ECS side, including:
the transceiver module 901, configured to determine authorization information of a V-ECS, and a target V-ECS; and
the processing module 902, configured to perform mutual identity authentication with the target V-ECS.

The processing module 902 is further configured to, in response to success of the mutual identity authentication, determine whether the target V-ECS is allowed to establish a connection with the H-ECS based on identity information authenticated and the authorization information of the V-ECS.

The processing module 902 is further configured to, in response to the target V-ECS being allowed to establish the connection with the H-ECS, establish a connection with the target V-ECS.

Alternatively, the transceiver module 901 is further configured to receive a first request sent by an EEC in a terminal, in which the first request includes the authorization information of the V-ECS.

Alternatively, the transceiver module 901 is further configured to:
receive a second request sent by an S-EES, in which the second request includes an identifier of a terminal;
send an obtaining request of the authorization information of the V-ECS to the terminal corresponding to the identifier of the terminal; and
receive the authorization information of the V-ECS returned by the terminal.

Alternatively, the processing module 902 is further configured to obtain the authorization information of the V-ECS from a preset storage area.

Alternatively, the processing module 902 is further configured to determine the target V-ECS based on location information of a terminal, in which the terminal is a terminal that sends the authorization information of the V-ECS to the H-ECS, or the terminal is a terminal that sends a V-ECS query request to the H-ECS.

Alternatively, the transceiver module 901 is further configured to send a first certificate to the target V-ECS, in which the first certificate is used for the target V-ECS to perform identity authentication on the H-ECS.

Alternatively, the processing module 902 is further configured to determine that identity information of the target V-ECS or a corresponding second certificate is included in a first list in the authorization information.

Alternatively, the transceiver module 901 is further configured to receive a second certificate sent by the target V-ECS; and the processing module 902 is further configured to perform identity authentication on the target V-ECS based on the second certificate.

Alternatively, the processing module 902 is further configured to perform authentication on the second certificate using a root CA corresponding to the target V-ECS; and in response to success of the authentication, determine that information in the second certificate is the identity information authenticated of the V-ECS.

Alternatively, the processing module 902 is further configured to:
in response to the identity information authenticated of the target V-ECS being included in the first list of the authorization information of the V-ECS, determine that the target V-ECS is allowed to establish the connection with the H-ECS; and/or
in response to the second certificate used for successfully authenticating the target V-ECS being included in the first list of the authorization information of the V-ECS, determine that the target V-ECS is allowed to establish the connection with the H-ECS.

Alternatively, the processing module 902 is further configured to establish a TLS connection with the target V-ECS based on the first certificate corresponding to the H-ECS and the second certificate corresponding to the target V-ECS.

In the disclosure, the H-ECS first determines the authorization information of the V-ECS and the target V-ECS; performs the mutual identity authentication with the target V-ECS; after the success of the mutual identity authentication, determines whether the target V-ECS is allowed to establish the connection with the H-ECS based on the identity information authenticated and the authorization information of the V-ECS; and establishes the connection with the target V-ECS in response to the target V-ECS being allowed to establish the connection with the H-ECS. Thus, before establishing the connection between the H-ECS and the target V-ECS, the identity authentication and authorization are performed, to avoid information leakage via the connection, to improve security and reliability of the connection between ECSs, and to improve a performance of a system in a roaming scenario.

Alternatively, the communication device 900 is in a V-ECS side, including:
the transceiver module 901, configured to perform mutual identity authentication with an H-ECS; and
the processing module 902, configured to, in response to success of the mutual identity authentication, determine whether the H-ECS is allowed to establish a connection with the V-ECS based on identity information authenticated and authorization information of the H-ECS.

The processing module 902 is further configured to, in response to the H-ECS being allowed to establish the connection with the V-ECS, establish a connection with the H-ECS.

Alternatively, the processing module 902 is further configured to:
extract the authorization information of the H-ECS from configuration information; or
determine the authorization information of the H-ECS based on a protocol.

Alternatively, the transceiver module 901 is further configured to receive a first certificate sent by the H-ECS; and
the processing module 902 is further configured to perform identity authentication on the H-ECS based on the first certificate.

Alternatively, the processing module 902 is further configured to perform authentication on the first certificate using a root CA corresponding to the H-ECS; and
in response to success of the authentication, determine that information in the first certificate is the identity information authenticated of the H-ECS.

Alternatively, the transceiver module 901 is further configured to, in response to the H-ECS being allowed to establish the connection with the V-ECS, send a second certificate to the H-ECS.

Alternatively, the processing module 902 is further configured to, in response to the identity information authenticated of the H-ECS being comprised in a first list of the authorization information of the H-ECS, determine that the H-ECS is allowed to establish the connection with the V-ECS; or
in response to the first certificate used for successfully authenticating the H-ECS being included in a first list of the authorization information of the H-ECS, determine that the H-ECS is allowed to establish the connection with the V-ECS.

Alternatively, the processing module 902 is further configured to establish a TLS connection with the H-ECS based on the first certificate corresponding to the H-ECS and the second certificate corresponding to the V-ECS.

In the disclosure, before establishing the connection with the H-ECS, the V-ECS may first perform the mutual identity authentication with the H-ECS; in response to the success of the mutual identity authentication, determine whether the H-ECS is allowed to establish the connection with the V-ECS based on the identity information authenticated and the authorization information of the H-ECS; and establish the connection with the H-ECS in response to the H-ECS being allowed to establish the connection with the V-ECS. Thus, before establishing the connection between the H-ECS and the target V-ECS, the identity authentication and authorization are performed, to avoid information leakage via the connection, to improve security and reliability of the connection between ECSs, and to improve a performance of a system in a roaming scenario.

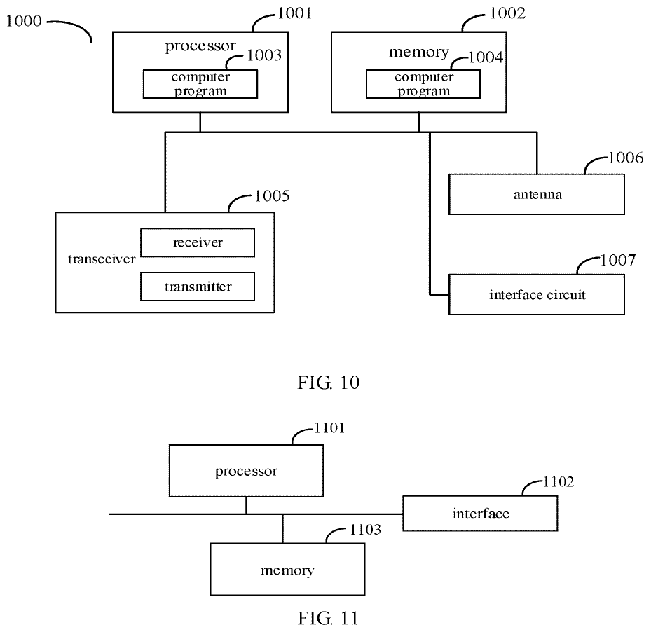

Please refer to FIG. 10, which is a block diagram illustrating a communication device according to another embodiment of the disclosure. The communication device 1000 may be an H-ECS, or a chip, a chip system, a processor, etc. that supports the H-ECS to realize the method; or a V-ECS, or a chip, a chip system, a processor, etc. that supports the V-ECS to realize the method. The device may be used to realize the method in the above method embodiments. For details, please refer to the above method embodiments.

The communication device 1000 may include one or more processors 1001. The processor 1001 may be a general purpose processor or a special purpose processor, such as, a baseband processor or a central processing unit. The baseband processor may be used to process communication protocols and communication data, and the central processing unit may be used to control the communication device (such as a base station, a baseband chip, a terminal, a terminal chip, a DU or a CU, etc.), execute a computer program, and process data of the computer program.

Alternatively, the communication device 1000 may also include one or more memories 1002 for storing a computer program 1004. The computer program 1004 may be executed by the processor 1001, to cause the communication device 1000 to realize the method in the above method embodiments. Alternatively, the memory 1002 may also store data. The communication device 1000 and the memory 1002 may be set separately or integrated together.

Alternatively, the communication device 1000 may also include a transceiver 1005 and an antenna 1006. The transceiver 1005 may be called a transceiver unit, a transceiver machine, or a transceiver circuit, etc., to realize the receiving and sending function. The transceiver 1205 may include a receiver and a transmitter, and the receiver may be called a receiving machine or a receiving circuit, etc. to realize the receiving function; and the transmitter may be called a transmitting machine or a transmitting circuit, etc. to realize the sending function.

Alternatively, the communication device 1000 may also include one or more interface circuits 1007. The interface circuit 1007 is configured to receive code instructions and transmit the code instructions to the processor 1001. The processor 1001 runs the code instructions to cause the communication device 1000 to realize the method in the above method embodiment.

The transceiver 1005 in the communication device 1000 may be configured to perform sending and receiving steps in each diagram, and the processor 1001 may be configured to perform processing steps in each diagram.

In an implementation, the processor 1001 may include a transceiver for realizing the receiving and sending function. For example, the transceiver may be a transceiver circuit, or an interface, or an interface circuit. The transceiver circuit, the interface, or the interface circuit for realizing the receiving and sending function may be separate or integrated. The transceiver circuit, the interface or the interface circuit may be configured to read and write code/data, or the transceiver circuit, the interface or the interface circuit may be configured to transmission of a signal.

In an implementation, the processor 1001 may store a computer program 1003. When the computer program 1003 is run in the processor 1001, the communication device 1000 is caused to execute the method in the above method embodiments. The computer program 1003 may be solidified in the processor 1001, in which case the processor 1001 may be realized in hardware.

In an implementation, the communication device 1000 includes a circuit that may realize the sending or receiving or communicating function in the above method embodiments. The processor and transceiver in the disclosure may be realized in an integrated circuit (IC), an analog IC, a radio frequency integrated circuit (RFIC), a mixed-signal IC, an application specific integrated circuit (ASIC), a printed circuit board (PCB), an electronic device, etc. The processor and transceiver may also be manufactured with various IC process technologies, such as a complementary metal oxide semiconductor (CMOS), nMetal-oxide-semiconductor (NMOS), a positive channel metal oxide semiconductor (PMOS), a bipolar junction transistor (BJT), a bipolar CMOS (BiCMOS), silicon germanium (SiGe), gallium arsenide (GaAs), etc.

The communication device/apparatus in the above embodiments may be a network device or an intelligent relay, but the scope of the communication device/apparatus in the disclosure is not limited to this, and the structure of the communication device/apparatus may not be restricted by FIG. 10. The communication device/apparatus may be an independent device or part of a larger device. For example, the communication device/apparatus may be:
(1) an independent IC, or a chip, or a chip system or a subsystem;
(2) a collection including one or more IC, alternatively, the IC collection including storage components for storing data and a computer program;
(3) an ASIC, such as a modem;
(4) modules embedded in other devices;
(5) a receiver, a terminal, an intelligent terminal, a cellular phone, a wireless device, a handheld phone, a mobile unit, a vehicle-mounted device, a network device, a cloud device, an artificial intelligence device, etc.;
(6) others.

For the case where the communication device/apparatus may be a chip or a chip system, please refer to the block diagram of a chip in FIG. 11. The chip illustrated in FIG. 11 includes a processor 1101 and an interface 1102. There may be one or more processors 1101, and there may be one or more interfaces 1102.

For the condition where the chip is configured to perform the functions of the terminal in embodiments of the disclosure:
alternatively, the chip also includes a memory 1103, which is configured to store necessary computer programs and data.

Those skilled in the art may also understand that the various illustrative logical blocks and steps listed in embodiments of the disclosure may be implemented by electronic hardware, computer software, or their combination. Whether such a function is implemented in hardware or software depends on specific applications and design requirements of the overall system. Those skilled in the art may, for each specific application, use a variety of methods to realize the above function, but such implementation shall not be regarded as going beyond the scope of the protection of the embodiments of the disclosure.

The disclosure further provides a non-transitory computer-readable storage medium for storing instructions. When the instructions are executed by a computer, the function of any one of the above method embodiments is performed.

The disclosure further provides a computer program product. When the computer program product is executed by a computer, the function of any one of the above method embodiments is performed.

In the above embodiments, the functions may be wholly or partially implemented by software, hardware, firmware, or any combination of them. When implemented by software, the functions may be implemented in whole or in part in the form of a computer program product. The computer program product includes one or more computer programs. Procedures or functions according to embodiments of the disclosure are wholly or partially generated when the computer program is loaded and executed on a computer. The computer may be a general purpose computer, a special purpose computer, a computer network, or other programmable device. The computer program may be stored in a non-transitory computer-readable storage medium or transmitted from one non-transitory computer-readable storage medium to another. For example, the computer program may be transmitted from one website, computer, server, or data center to another website, computer, server, or data center via wire (such as a coaxial cable, a fiber optic, a digital subscriber line (DSL)) or wireless (such as infrared, wireless, microwave). The non-transitory computer-readable storage medium may be any available medium that may be accessed by a computer, or a data storage device such as a server that integrates one or more of the available media, and a data center. The available medium be a magnetic medium (such as a floppy disk, a hard disk and a magnetic tape), an optical medium (such as a digital video disk (DVD)), or a semiconductor medium (such as a solid state disk (SSD)).

Those skilled in the art may understand that numbers like “first” and “second” in the disclosure are only for the convenience of description, and are not used to limit the scope of embodiments of the disclosure, and also indicate a sequential order.

The term “at least one” in the disclosure may also be described as one or more, and the more may be two, three, four, or more, which is not limited in the disclosure. In the embodiment of the disclosure, for a technical feature, the technical feature in the technical features are distinguished by terms “first”, “second”, “third”, “A”, “B”, “C” and “D”, etc., and the technical features described by the terms “first”, “second”, “third”, “A”, “B”, “C” and “D”, etc. are not in a sequential order or in an order of size.

Corresponding relationships indicated by tables in the disclosure may be configured or predefined. Values of information in the tables are only examples, and may be configured as other values, which are not limited in the disclosure. When the corresponding relationship between information and parameters is configured, there is no need always to configure all corresponding relationships indicated in tables. For example, in the tables of the disclosure, corresponding relationships indicated by some rows may not be configured. For another example, appropriate transformations and adjustments, such as splitting and merging, may be made based on the above tables. Names of parameters illustrated in headers of the tables may be other names understandable by the communication device, and values or representations of the parameters may be other values or representations understandable by the communication device. When the above tables are implemented, other data structures may be used, for example, arrays, queues, containers, stacks, linear lists, pointers, linked lists, trees, graphs, structures, classes, heaps or hash tables may be used.

Predefined in the disclosure may be understood as defined, predefined, stored, pre-stored, pre-negotiated, pre-configured, solidified or pre-fired.

Those skilled in the related art may realize that, units and algorithm steps of the examples described in embodiments of the disclosure, may be implemented by an electronic hardware or a combination of an electronic hardware and a computer software. Whether the functions are executed by the hardware or the software depends on a specific application and a design constraint of the technical solutions. Those skilled in the art may adopt different methods for each specific application to realize the described functions, but such implementation should not be considered as going beyond the scope of the disclosure.

Those skilled in the art may clearly understand that, a detailed working process of a system, an apparatus and a unit described above may refer to a corresponding process in the above method embodiments, which will not be repeated here.

The above are only implementations of the disclosure. However, the protection scope of the disclosure is not limited here. Changes and substitutions that may be easily considered by those skilled in the art shall be contained within the protection scope of the disclosure. Therefore, the protection scope of the disclosure shall be subject to the protection scope of claims.

1. A method for establishing a connection, performed by a home edge configuration server (H-ECS), comprising:
determining authorization information of a visited edge configuration server (V-ECS), and a target V-ECS;
performing mutual identity authentication with the target V-ECS;
in response to success of the mutual identity authentication, determining whether the target V-ECS is allowed to establish a connection with the H-ECS based on identity information authenticated and the authorization information of the V-ECS; and
in response to the target V-ECS being allowed to establish the connection with the H-ECS, establishing a connection with the target V-ECS.

2. The method of claim 1, wherein a process of determining the authorization information of the V-ECS comprises:
receiving a first request sent by an edge enabler client (EEC) in a terminal, wherein the first request comprises the authorization information of the V-ECS.

3. The method of claim 1, wherein a process of determining the authorization information of the V-ECS comprises:
receiving a second request sent by a source edge enabler server (S-EES), wherein the second request comprises an identifier of a terminal;
sending an obtaining request of the authorization information of the V-ECS to the terminal corresponding to the identifier of the terminal; and
receiving the authorization information of the V-ECS returned by the terminal.

4. The method of claim 1, wherein a process of determining the authorization information of the V-ECS comprises:
obtaining the authorization information of the V-ECS from a preset storage area.

5. The method of claim 1, wherein a process of determining the target V-ECS comprises:
determining the target V-ECS based on location information of a terminal, wherein the terminal is a terminal that sends the authorization information of the V-ECS to the H-ECS, or the terminal is a terminal that sends a V-ECS query request to the H-ECS.

6. The method of claim 1, wherein performing the mutual identity authentication with the target V-ECS comprises:
sending a first certificate to the target V-ECS, wherein the first certificate is used for the target V-ECS to perform identity authentication on the H-ECS.

7. The method of claim 6, before sending the first certificate to the target V-ECS, further comprising:
determining that identity information of the target V-ECS or a corresponding second certificate is comprised in a first list in the authorization information.

8. The method of claim 1, wherein performing the mutual identity authentication with the target V-ECS comprises:
receiving a second certificate sent by the target V-ECS; and
performing identity authentication on the target V-ECS based on the second certificate.

9. The method of claim 8, wherein performing the identity authentication on the target V-ECS based on the second certificate comprises:
performing authentication on the second certificate using a root certificate authority (CA) corresponding to the target V-ECS; and
in response to success of the authentication, determining that information in the second certificate is the identity information authenticated of the V-ECS.

10. The method of claim 1, wherein determining whether the target V-ECS is allowed to establish the connection with the H-ECS based on the identity information authenticated and the authorization information of the V-ECS comprises:
in response to the identity information authenticated of the target V-ECS being comprised in the first list of the authorization information of the V-ECS, determining that the target V-ECS is allowed to establish the connection with the H-ECS; or
in response to the second certificate used for successfully authenticating the target V-ECS being comprised in the first list of the authorization information of the V-ECS, determining that the target V-ECS is allowed to establish the connection with the H-ECS.

11. The method of claim 1, wherein establishing the connection with the target V-ECS comprises:
establishing a transport layer security (TLS) connection with the target V-ECS based on the first certificate corresponding to the H-ECS and the second certificate corresponding to the target V-ECS.

12. A method for establishing a connection, performed by a visited edge configuration server (V-ECS), comprising:
performing mutual identity authentication with a home edge configuration server (H-ECS);
in response to success of the mutual identity authentication, determining whether the H-ECS is allowed to establish a connection with the V-ECS based on identity information authenticated and authorization information of the H-ECS; and
in response to the H-ECS being allowed to establish the connection with the V-ECS, establishing a connection with the H-ECS.

13. The method of claim 12, further comprising:
extracting the authorization information of the H-ECS from configuration information; or
determining the authorization information of the H-ECS according to a protocol.

14. The method of claim 12, wherein performing the mutual identity authentication with the H-ECS comprises:
receiving a first certificate sent by the H-ECS; and
performing identity authentication on the H-ECS based on the first certificate.

15. The method of claim 14, wherein performing identity authentication on the H-ECS based on the first certificate comprises:
performing authentication on the first certificate using a root certificate authority (CA) corresponding to the H-ECS; and
in response to success of the authentication, determining that information in the first certificate is the identity information authenticated of the H-ECS.

16. The method of claim 12, wherein performing the mutual identity authentication with the H-ECS comprises:
in response to the H-ECS being allowed to establish the connection with the V-ECS, sending a second certificate to the H-ECS.

17. The method of claim 12, wherein determining whether the H-ECS is allowed to establish the connection with the V-ECS based on the identity information authenticated and preset authorization information of the H-ECS comprises:
in response to the identity information authenticated of the H-ECS being comprised in a first list of the authorization information of the H-ECS, determining that the H-ECS is allowed to establish the connection with the V-ECS; or
in response to the first certificate used for successfully authenticating the H-ECS being comprised in a first list of the authorization information of the H-ECS, determining that the HI-ECS is allowed to establish the connection with the V-ECS.

18. The method of claim 12, wherein establishing the connection with the H-ECS comprises:
establishing a transport layer security (TLS) connection with the H-ECS based on the first certificate corresponding to the H-ECS and the second certificate corresponding to the V-ECS.

19. A home edge configuration server (H-ECS), comprising:
a processor; and
a memory for storing instructions executable by the processor,
wherein the processor is configured to:
determine authorization information of a visited edge configuration server (V-ECS), and a target V-ECS;
perform mutual identity authentication with the target V-ECS;
in response to success of the mutual identity authentication, determine whether the target V-ECS is allowed to establish a connection with the H-ECS based on identity information authenticated and the authorization information of the V-ECS; and
in response to the target V-ECS being allowed to establish the connection with the H-ECS, establish a connection with the target V-ECS.

20. A visited edge configuration server (V-ECS), comprising:
a processor; and
a memory for storing instructions executable by the processor,
wherein the processor is configured to execute the method of claim 12.

21-23. (canceled)
